(19) United States
(12) Patent Application Publication
(10) Pub. No.: US 2010/0211576 A1
(43) Pub. Date: Aug. 19, 2010

(54) Method And System For Similarity Matching

(76) Inventor: J.R. Johnson, El Segundo, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/708,494

(22) Filed: Feb. 18, 2010

Related U.S. Application Data
(60) Provisional application No. 61/153,542, filed on Feb. 18, 2009.

(51) Int. Cl. G06F 17/30

(52) U.S. Cl. 707/749; 707/E17.014

(57) ABSTRACT

A method and system for similarity matching are disclosed. According to one embodiment, a computer-implemented method comprises calculating a data point value by a server related to one or more of a client creating a data point, editing facts about the data point, providing an opinion about the data point, rating the data point, and rating the opinion about the data point. An opinion value is received from the client. A weighted value is calculated by the server from the data point value. A similarity score is computed between the client and a second client based upon the weighted value. A similarity network of clients for the client is determined based upon the similarity score. The similarity network of clients is filtered based upon tags provided to the client by the server.

The present application claims the benefit of and priority to U.S. Provisional Patent Application No. 61/153,542 entitled “A METHOD AND SYSTEM FOR SIMILARITY MATCHING” filed on Feb. 18, 2009, and is hereby, incorporated by reference.

### FIELD

The present system relates in general to computer applications and, more specifically, to a method and system for similarity matching.

### BACKGROUND

Today, there are many ways for individuals to find others with similar interests online. More specifically, numerous web sites exist that enable users to search publicly available information to identify other individuals with the same interests. For instance, web sites such as networking sites and dating sites typically enable a user to create an online public profile, enabling the user to search for and locate other individuals with similar interests among other publicly available profiles.

Unfortunately, public profiles contain only limited information about the individuals who created them. Moreover, the information that individuals present in their public profiles is often deceptive. As a result, the time and energy an individual invests to search these public profiles often yields less than desirable results. In addition, it is becoming more and more difficult for users of the Internet to quickly find information they can trust.

### SUMMARY

A method and system for similarity matching are disclosed. According to one embodiment, a computer-implemented method comprises calculating a data point value by a server related to one or more of a client creating a data point, editing facts about the data point, providing an opinion about the data point, rating the data point, and rating the opinion about the data point. An opinion value is received from the client. A weighted value is calculated by the server from the data point value. A similarity score is computed between the client and a second client based upon the weighted value. A similarity network of clients for the client is determined based upon the similarity score. The similarity network of clients is filtered based upon tags provided to the client by the server.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

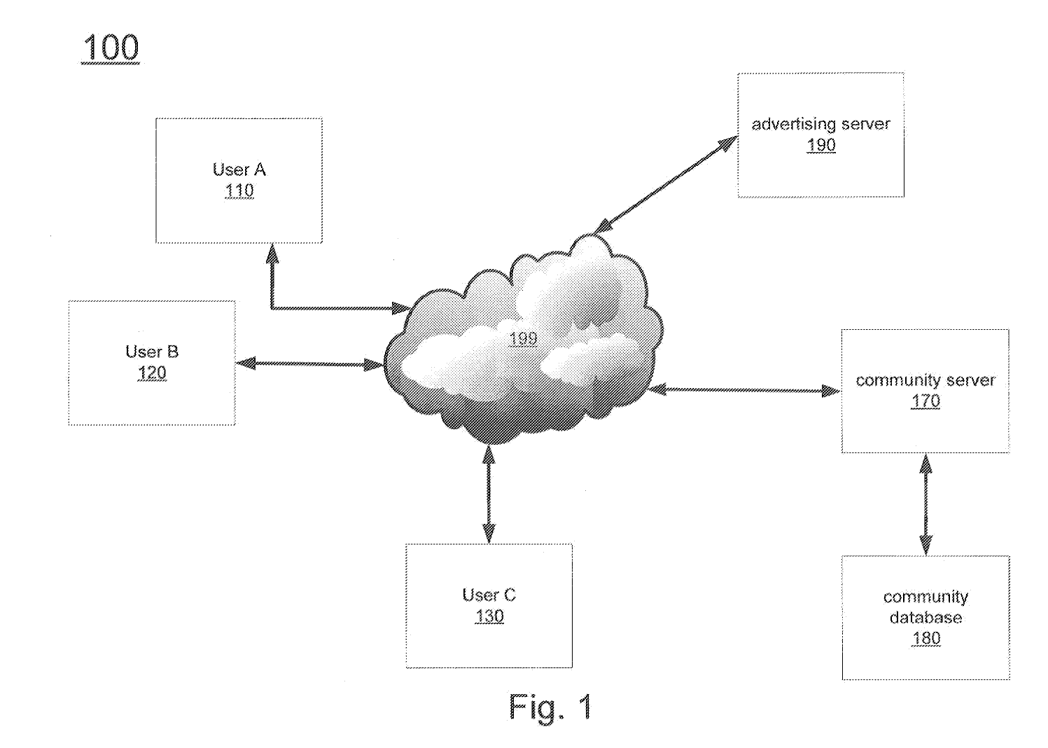

FIG. 1 illustrates a block diagram of the network architecture for an exemplary similarity matching system, according to one embodiment.

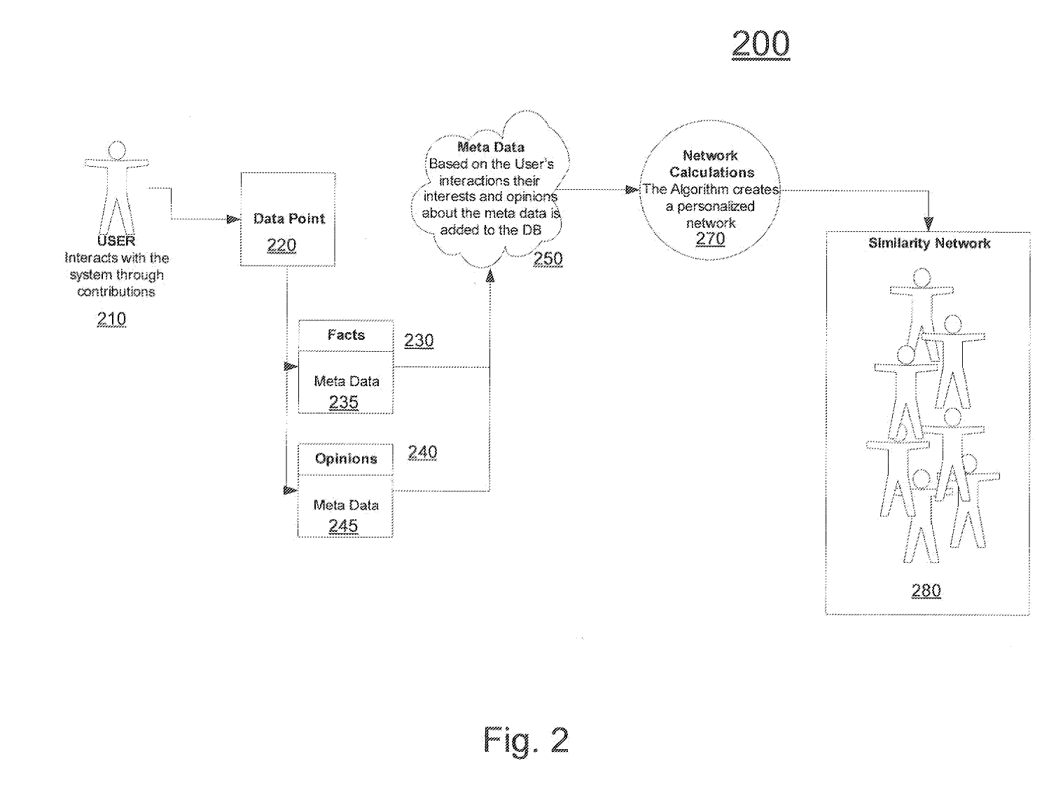

FIG. 2 illustrates an exemplary similarity network generation process, according to one embodiment.

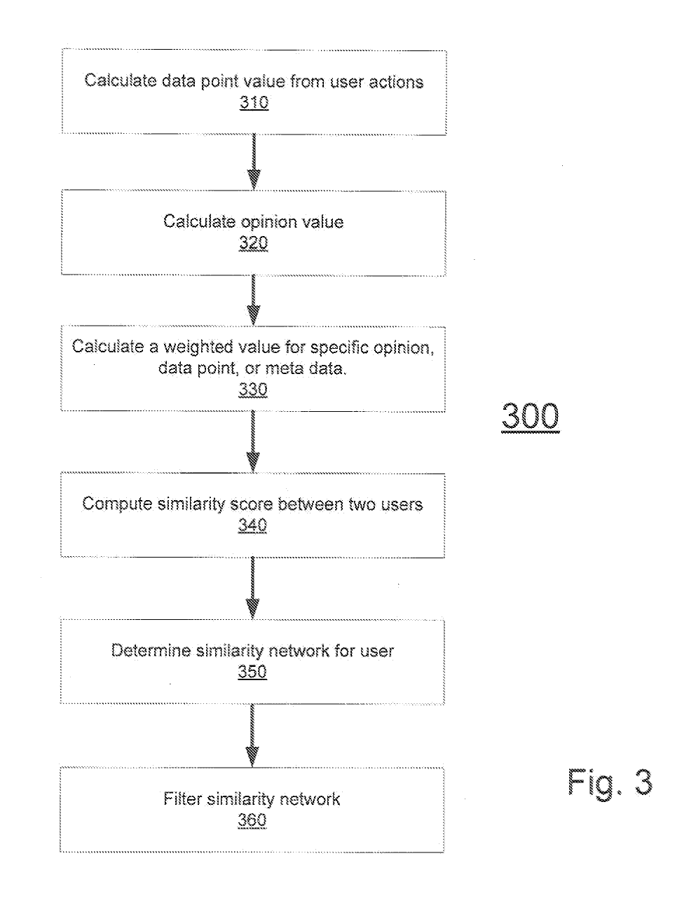

FIG. 3 illustrates an exemplary personalized similarity network generation process, according to another embodiment.

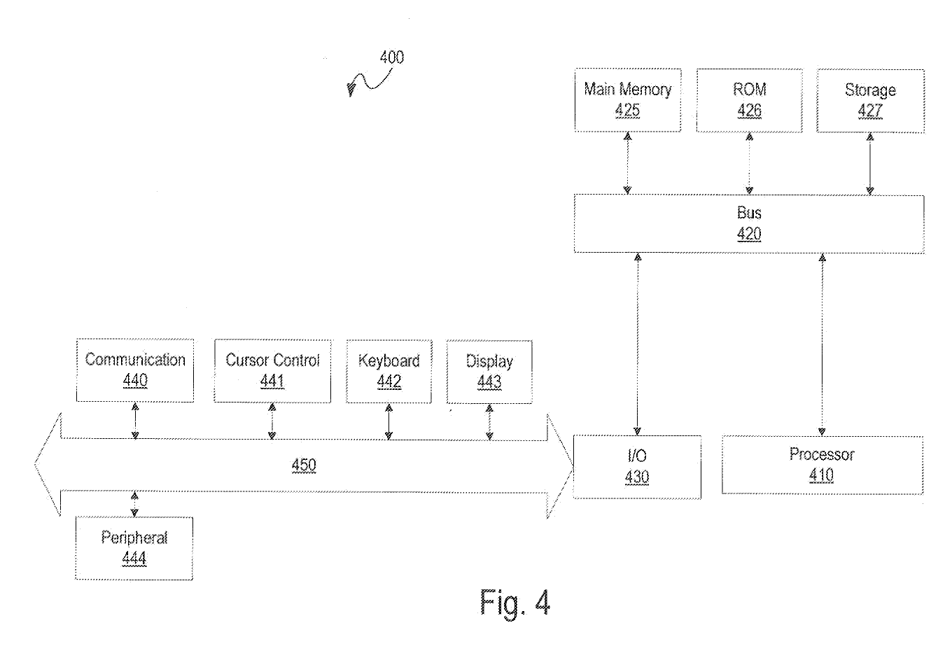

FIG. 4 illustrates an exemplary computer architecture for use with the present system, according to one embodiment.

It should be noted that the figures are not necessarily drawn to scale and that elements of structures or functions are generally represented by reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for similarity matching are disclosed. According to one embodiment, a computer-implemented method comprises calculating a data point value by a server related to one or more of a client creating a data point, editing facts about the data point, providing an opinion about the data point, rating the data point, and rating the opinion about the data point. An opinion value is received from the client. A weighted value is calculated by the server from the data point value. A similarity score is computed between the client and a second client based upon the weighted value. A similarity network of clients for the client is determined based upon the similarity score. The similarity network of clients is filtered based upon tags provided to the client by the server.

The present system is an on-line community based on finding common ground of one user with other users. The present system connects a user to other users with common interests while also uncovering your common ground with users who may seem to be total opposites.

The system features reviews, lists, and ratings contributed from the community on almost any topic. For example, the latest YouTube video, to a local mechanic, a life philosophy, a snowboard, universal healthcare, or a rock concert, it's a place for all interests. Based on what a user shares, the user is connected to a similarity network of users who share the user's opinions and perspective. Through them, for example, the user can discover a mystery novel she has never heard of, a great local animal hospital, or the best place to buy folding bikes. The user can also learn a bit more about users otherwise never encountered.

The user rates the helpfulness of what is found on the system, and the system filters out the noise to give the user what's most relevant and useful. In turn, the user's feedback encourages other users to create better, more thoughtful content.

The present system is a social sharing network where users contribute facts and opinions about almost everything. Based on your contributions, the present system connects a user to a similarity network of people who share his/her opinions and ideas.

FIG. 1 illustrates a block diagram of the network architecture for an exemplary similarity matching system, according to one embodiment. Similarity matching system 100 includes users 110-130, advertising server 190, community server 170 and community database 180. Users 110-130 are clients of community server 170. All elements of the matching system 100 are interconnected via a network 199. The network connecting all elements of client-server system 100 may be any wide area network (WAN) 199, or local area network (LAN), or combination of LAN and WAN, generally referred to as the Internet.

The user clients 110-130 and servers 170, 190 can be any type of computing device including a personal computer. The workstations (clients 130 and servers 140) may be a combination of proxy servers, web servers, application servers, and database servers. Web servers are responsible for handling the incoming client requests, decrypting the secure connection, bridging to the application server for dynamic content, and serving static content. Web servers tend to have relatively little load since the majority of the application is dynamic in nature. The management and gateway servers take care of periodic batch processes, integration tasks, and other monitoring functions. Performing these functions on dedicated machines but often provides an enhanced level of security by better isolating the application servers and providing finer grained control of system resources. The application servers run the business components and related functionality. Typically, the J2EE web application executes on the application servers along with the EJB and middleware components for enhanced performance, though these functions can be separated if desired.

Workstations (user clients 110-130 and servers 170, 190) may be any of a SUN Microsystems, HP, IBM, Dell, Intel server, or similar computing device. Various operating systems are supported on the workstations, such as Sun Solaris, AIX, Microsoft Windows, zOS, Linux, and MacOS. Workstations also run various software components such as Apache, etc.

Typically, community database 180 will comprise a SQL (structured query language) relational database management system (RDBMS) database, such as one of the SQL RDBMS database products provided by Oracle, Microsoft (SQL Server), Sybase, and IBM. Optionally, the database 180 may comprise a non-SQL-based server product, such as the Microsoft's Access database or Paradox. The database servers run queries against the data models and execute data manipulation stored procedures. The wealth management data can be quite large, as major institutions will keep 18 months or more of historical data online across a wide customer base. According to one embodiment, RAID disk arrays are attached to the database server locally to provide local storage and facilitate high availability. The database machines, however, tend to use either fiber channel loops or a SAN to make a large, redundant storage array available to the database servers. This provides high performance across all the machines and minimizes the overhead and tasks required for system redundancy. Financial application architecture 300 supports both standard UNIX and Windows environments and selected database and management components can run on OS/390 as well.

Internet browsing is implemented through client user computers 110-130, HTTP server computers 170, 190 and HTTP browsers. Servers 170, 190 play the role of archives for providing data and client user computers 110-130 play the role of customers or consumers of the data. Typically many clients connect to a single server. Special server and client software may also be employed, depending on the specific application design architecture.

An Internet browser, such as Microsoft's Internet Explorer or Netscape's Communicator, is a piece of software which resides on a client user computers 110-130. When executed by a user, the browser opens a Uniform Resource Locator (URL), which resides on a community server 170. Typically, the URL is a Hyper-Text Markup Language (HTML) page, which is sent back from the community server 170 to the client user computers 110-130. The HTML page has instructions for the browser, which instruct the browser how to render the page for display. The page typically has additional URLs embedded in it, and when the user clicks on one of them, the community server 170 then sends a new HTML page for the browser to render.

HTML pages can contain both text and graphics, along with layout instructions. Images appearing on an HTML page also reside on the community server 170, and are sent to the client user computers 110-130 when the browser finds a link to an image on the HTML page it is rendering, and then instructs the community server 170 to send image data. The beauty of this is that the images reside on remote computers, and do not have to be stored locally on the client user computers 110-130. Otherwise, the client would have to store every image it views, either on its hard disk or on a storage medium such as CD-ROM, regularly replacing these images with updates. Both images and data can be stored in databases 180 that are attached to community server 170 directly or through network 199.

The actual data communication between the community server 170 and the client user computers 110-130 is governed by Internet protocols, such as Hyper-Text Transfer Protocol (HTTP). These protocols define packets of data to be sent, and can include handshakes for negotiating data-link control, to verify if the data arrived intact. Specifically, the HTTP protocol sits as a layer on top of TCP/IP protocol.

Similarity matching system 100 matches a user (eg. user A 110) with other users (eg. user B 120 and user C 130) based on their interaction with system content. Similarity matching system 100 matches a user with personally relevant content based on the user's connections to other users and the content that those users like. Similarity matching system 100 behaviorally targets users and serves ads to them that are relevant based on sentiments derived from the use of the website. Similarity matching system 100 matches serves relevant ads to users based on how relevant those ads were to users who are similar. For example, if user A 110 clicked on an Ad Z, and user B 120 is similar to user A 110, then using similarity matching, relevant Ad Z is served to user B 120.

Community server 170 includes a content engine. The content engine uses similarity matching to motivate a user (e.g. user A 110) to create quality monetize-able content. The content engine generates a user interface to encourage people to produce quality content to improve their network and recommendations. The present system provides a user generated content engine that allows users to produce various types of information for public consumption. The system consists of the following information types:

1. Data Points

2. Facts

3. Opinions

A data point is a specific object in the system that consists of, at the very least, a name and a definition. Each data point has opinions and facts attached to it. Community database 180 stores data points, names, definitions, opinions, facts, and meta data, text, attributes, tags, media, ratings, scores, values, in addition to user profile information.

A fact is community collaborative content that has:

1. Free form text or wiki

2. Key value pairs called Attributes

3. Tags (data descriptors)

4. And photos or media that are factual in nature and support the Data Point.

An opinion is a document created by one person that allows the user to opine on a data point. An opinion has:

1. An overall rating of a data pint stored on a 100 point scale.

2. An opinion title or headline

3. Opinion text

4. Photos or Media that help support the opinion

Each piece of content on matching system 100 contains meta data. Matching system 100 uses meta data as data descriptors for a specific piece of content. Most meta data in matching system 100 is generated by the user (eg. user A 110) and visible to the user. The following are examples of meta data in matching system 100:

1. Data Point Name

2. Data Point Definitions

3. Data Point Type

4. Data Point Annotations (Not visible to the user)

5. Attributes

6. Tags

7. Categories

8. Hubs

9. Hub Categories

10. Rating Context
a. Overall
b. Hub Category Opinion Scores

11. Review Ratings
a. Overall
b. Kudos

Based on the user's interactions, matching system 100 compiles the user's sentiments (data reflecting a mental attitude based on a mixture of thoughts and feelings) toward each piece of meta data and builds a network of people that share the same sentiments. The similarity between each user is communicated through the application in the form of an overall score and an accuracy indicator.

Each action a user takes in the application can indicate an interest or an opinion about a specific piece of meta data. The following actions indicate an interest:
Creating a data point
Editing facts about a data point
Giving an opinion about a data point
Rating a data point
Rating an opinion about a data point
Creating a Game
Creating a Hub

The following actions indicate a specific opinion:

1. The rating values given to a specific data point

2. The rating values given to a specific opinion

Through the user interface, user A 110 may view her overall network or filter her network based on different Meta data tags made available to her.

Scores are derived as follows:
1. When user A 110 assigns a specific opinion value to a data point or a review, user A 110 is expressing how much she likes or dislikes the specific object. The opinion value is stored on a 100 point scales.
2. When user A 110 interacts with content as defined above community server 170 tallies interest for the specific meta data (interactions are weighted differently depending on the degree of explicit intent). The interest as a whole number which is the sum of the weighted interactions for each specific meta data.
3. For example, user A 110 rates the book “Into the Wild” by Jon Krakauer. User

A 110 gave it a +4 Opinion. Because user A 110 rated the item he has expressed interest in the following; “Into the Wild”, Books, Jon Krakauer. With the strongest interest being in the specific book.
4. When comparing two users or creating the similarity network the system builds out each user's interest and opinion graph. Community server 170 then compares each user's opinion and interest graph and computes a similarity score. There are four components to the similarity score: interest, interest accuracy, opinion, and opinion accuracy. These components create the overall score and accuracy indicator.
5. Accuracy is the measure of overlap expressed as a percentage. As user A 110 and user B 120 have more overlap the accuracy indicator increases. Each user 110-130 can increase her accuracy score by interacting with community server 170.

User A 110, through community server 170 can rate interests, from video games or baby strollers to news headlines. User A 110, through community server 170 can Write reviews and create lists to share why you like, love, or loathe any given topic, and create wikis for the facts of the matter. User A 110, through community server 170 can create a micro review, to give a quick take in 140 characters. User A 110, through community server 170 may share contributions from community server 170 onto Twitter, Facebook, and many other social media sites—from Wordpress to Digg.

User A 110 through server 170 may create her profile and view her similarity network to find people who feel the same way about sushi, pet adoption, or Lost. User A 110 may get a few trusted reviews from her similarity network, rather than thousands from random sources across the Internet. User A 110 can start finding common ground with any other user (eg. User B 120) by clicking a similarity icon on each user's profile photo.

FIG. 2 illustrates an exemplary similarity network generation process, according to one embodiment. User A 110, interacts with community server 170 by providing contributions (210). Using the contributions, community server 170 creates data points (220). The data points 220 may be facts 230 having fact meta data 235, opinions 240, and opinion meta data 245. Meta data 235 and 245 is stored in community database 180 (250). Community server 170 creates a personalized similarity network 280.

FIG. 3 illustrates an exemplary personalized similarity network generation process, according to another embodiment. A data point value is calculated based upon user A's actions with community server 170 (310). The data point value may be calculated when user A 110 creates a data point, edits facts about a data point, gives an opinion about a data point, rates a data point, rates an opinion about a data point, creates a game, and/or creates a hub.

When user A 110 assigns a specific opinion value to a data point or a review, user A 110 is expressing how much she likes or dislikes the specific object. The opinion value is stored on a 100 point scale (320). Community server 170 calculates a weighted value for a specific opinion, data point, or meta data (330). From the weighted value, community server 170 computes a similarity score between two users (eg. user A 110 and user B 120) (340). There are four components to the similarity score: interest, interest accuracy, opinion, and opinion accuracy. These components create the overall score and accuracy indicator.

Using the weighted values, and similarity scores and other information, community server 170 determines the personalized similarity network for user A 110 (350). User A 110 may filter her personalized similarity network based on different meta data tags made available to her from community server 170 (360).

FIG. 4 illustrates an exemplary computer architecture for use with the present system, according to one embodiment. One embodiment of architecture 400 comprises a system bus 420 for communicating information, and a processor 410 coupled to bus 420 for processing information. Architecture 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Architecture 400 also may include a read only memory (ROM) and/or other static storage device 426 coupled to bus 420 for storing static information and instructions used by processor 410.

A data storage device 427 such as a magnetic disk or optical disc and its corresponding drive may also be coupled to computer system 400 for storing information and instructions. Architecture 400 can also be coupled to a second I/O bus 450 via an I/O interface 430. A plurality of I/O devices may be coupled to I/O bus 450, including a display device 443, an input device (e.g., an alphanumeric input device 442 and/or a cursor control device 441).

The communication device 440 allows for access to other computers (servers or clients) via a network. The communication device 440 may comprise one or more modems, network interface cards, wireless network interfaces or other well known interface devices, such as those used for coupling to Ethernet other types of networks.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any, type of disk including floppy disks, optical disks, CD-ROMS, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

A method and system for similarity matching are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

I claim:

1. A computer-implemented method, comprising:
calculating a data point value by a server related to one or more of a client creating a data point, editing facts about the data point, providing an opinion about the data point, rating the data point, and rating the opinion about the data point;
receiving an opinion value from the client;
calculating a weighted value by the server from the data point value;
computing a similarity score between the client and a second client based upon the weighted value;
determining a similarity network of clients for the client based upon the similarity score; and
filtering the similarity network of clients based upon tags provided to the client by the server.
